(19) United States
(12) Patent Application Publication
(10) Pub. No.: US 2014/0266702 A1
(43) Pub. Date: Sep. 18, 2014

(54) Safety Monitor Application

(71) Applicant: South East Water Corporation, Heatherton (AU)

(72) Inventor: Andrew Forster-Knight, Oak Park (AU)

(73) Assignee: South East Water Corporation, Heatherton (AU)

(21) Appl. No.: 13/836,536

(22) Filed: Mar. 15, 2013

(51) Int. Cl. G08B 21/04; H04W 4/12; H04W 4/02

(52) U.S. Cl. CPC G08B 21/0423; H04W 4/025; H04W 4/12
USPC 340/539.13

(57) ABSTRACT

Embodiments relate generally to methods and systems for providing a computerised safety monitor application in a handheld mobile computing device. An example method comprises: within the safety monitor application, allowing user configuration of a monitor time period; executing a timer function to run a timer from a beginning of the monitor time period; in response to a signal from the movement detection component indicative of movement of the mobile computing device by more than a threshold movement amount, resetting the timer to run from the beginning of the monitor period; and in response to the timer reaching an end of the monitor time period, generating and transmitting an alarm message to at least one remote destination using the wireless communication means of the handheld mobile computing device.

### TECHNICAL FIELD

Described embodiments generally relate to safety monitor applications. In particular, embodiments relate to such applications and methods of their use and provision and to mobile computing devices executing such applications.

### BACKGROUND

Many workers may routinely perform work in remote locations while alone. For example, a maintenance worker or inspection personnel may regularly travel to sites alone in order to gather information or perform some checking or maintenance functions. With workers that travel and work alone, the possible effects of safety hazards experienced by such workers can be potentially of greater threat to such workers, and by extension, their employers, because there are no co-workers to mitigate such safety hazards and/or report a safety incident that may have left the worker unable to call for help.

It is desired to address or ameliorate one or more shortcomings or disadvantages associated with prior safety monitoring techniques for lone workers, or to at least provide a useful alternative thereto.

### SUMMARY

Some embodiments relate to, in a handheld mobile computing device comprising a movement detecting component and a wireless communication subsystem, a method of providing a safety monitor application, the method comprising:
within the safety monitor application, allowing user configuration of a monitor time period;
executing a timer function to run a timer from a beginning of the monitor time period;
in response to a signal from the movement detection component indicative of movement of the mobile computing device by more than a threshold movement amount, resetting the timer to run from the beginning of the monitor period;
in response to the timer reaching an end of the monitor time period, generating and transmitting an alarm message to at least one remote destination using the wireless communication subsystem of the handheld mobile computing device.

The method may further comprise, in response to a user input to the mobile computing device, resetting the timer to run from the beginning of the monitor period. The alarm message may be transmitted to at least two pre-configured contacts.

The mobile computing device may have a geographic location identification function and the method may further comprise determining a geographic location of the mobile computing device, wherein the alarm message includes at least one of a geographic location and a selectable link to display the geographic location.

The alarm message may comprise an indication of the monitor time period. The generating and transmitting may be performed after a pre-configured delay period after the end of the monitor period. The method may further comprise determining a location accuracy of the determined geographic location, wherein the alarm message includes the location accuracy. Determining the geographic location may be performed repeatedly during the monitor time period. The method may further comprise displaying on a display of the mobile computing device an indication of the location accuracy.

The method may further comprise displaying on a display of the mobile computing device an indication of a remaining time until the end of the monitor period. The method may further comprise displaying on a display of the mobile computing device a panic alarm option, wherein the method further comprises, in response to selection of the panic alarm option, generating and transmitting a panic alarm message to the at least one remote destination. The method may further comprise displaying on a display of the mobile computing device a selectable timer initiation option, wherein in response to selection of the timer initiation option, the timer function causes the timer to run from the beginning of the monitor time period.

The at least one remote destination may be a server paired with the safety monitor application. The server may be configured to generate and transmit one or more second alarm messages to one or more destination devices.

Some embodiments relate to a safety monitor system for implementation in a handheld mobile computing device comprising a movement detecting component and a wireless communication subsystem, the system comprising:
at least one processor;
memory accessible to the at least one processor and storing program code executable by the at least one processor to cause the at least one processor to:
   allow user configuration of a monitor time period;
   execute a timer function to run a timer from a beginning of the monitor time period;
   in response to a signal from the movement detection component indicative of movement of the handheld mobile computing device by more than a threshold movement amount, resetting the timer to run from the beginning of the monitor period;
   in response to the timer reaching an end of the monitor time period, generating and transmitting an alarm message to at least one remote destination using the wireless communication subsystem of the handheld mobile computing device.

Some embodiments relate to a method of providing a safety monitor application, comprising:
downloading the safety monitor application onto a handheld mobile computing device comprising a movement detecting component and a wireless communication subsystem;
wherein the handheld computing device further comprises at least one processor and memory accessible to the at least one processor and storing program code executable by the at least one processor;
wherein in response to the downloading, the program code stored in the memory includes the safety monitor application;
wherein execution of the safety monitor application by the at least one processor causes the at least one processor to:
   allow user configuration of a monitor time period;
   execute a timer function to run a timer from a beginning of the monitor time period;
   in response to a signal from the movement detection component indicative of movement of the handheld mobile computing device by more than a threshold movement amount, resetting the timer to run from the beginning of the monitor period;
   in response to the timer reaching an end of the monitor time period, generating and transmitting an alarm message to at least one remote destination using the wireless communication subsystem of the handheld mobile computing device.

Some embodiments relate to, in a handheld mobile computing device comprising a location detecting component and a wireless communication subsystem, a method of providing a safety monitor application, the method comprising:
within the safety monitor application, allowing user configuration of an interval time period;
executing a timer function to run a timer from a beginning of the interval time period;
in response to user input to reset the timer, resetting the timer to run from the beginning of the interval period;
determining a geographic location of the handheld mobile computing device;
in response to the timer reaching an end of the interval time period, generating and transmitting an alarm message to at least one remote destination using the wireless communication subsystem of the handheld mobile computing device, the alarm message including at least one of the determined geographic location and a selectable link to display the determined geographic location.

### BRIEF DESCRIPTION OF DRAWINGS

Embodiments are described in further detail below, by way of example, with reference to the accompanying drawings, in which:

FIG. 1 is a block diagram of a safety monitor system according to some embodiments;

FIG. 2 is a flowchart of a method of providing a safety monitor application for a hand held mobile computing device;

FIG. 3 is a flowchart of a method of executing a monitor application in a motion detection mode;

FIG. 4 is a flowchart of a method of executing a monitor application in an interval timer mode;

FIGS. 5A, 5B and 5C are example screen displays of introduction pages displayed to a user viewing the safety monitor application;

FIG. 6A is an example screen display of a configuration page of the safety monitor application;

FIG. 6B is an example screen display of the configuration page of FIG. 6A, showing further detail of that page;

FIG. 7 is an example screen display of a timer actuation and status display screen;

FIG. 8 is an example screen display of a further timer actuation and status screen of the safety monitor application;

FIG. 9 is an example screen display of an alert message displayed by the safety monitor application when one or more alarm messages has been transmitted;

FIG. 10 is an example message display of an alarm message transmitted as an electronic mail message and received at a designated alarm contact address; and

FIG. 11 is an example message display of an alarm message transmitted as a text message and received at a designated alarm contact mobile device number.

### DETAILED DESCRIPTION

Described embodiments generally relate to safety monitor applications. In particular, embodiments relate to such applications and methods of their use and provision and to mobile computing devices executing such applications.

Referring now to FIG. 1, a system 100 for providing a safety monitor application is described in further detail. System 100 comprises a hand held mobile computing device 110 in communication with a server 145 over one or more public networks 140.

The hand-held computing device 110 may be embodied as a smart phone or tablet computing device, for example. The server 145 has an interface module 147 specifically configured to pair with and interface with a safety monitor application 118 executing on the hand held mobile computing device 110. The system 100 further comprises a data store 146 in communication with, and accessible to, the server 145 to store data relating to the use of the safety monitor application 118 and the status updates that it generates. Additionally, system 100 may comprise one or more destination devices 150 to receive alarm messages from the server 145, depending on the monitored safety status received from the safety monitor application 118.

System 100 further comprises a download server 160 to facilitate the download of the safety monitor application 118 to the handheld mobile computing device 110.

In some embodiments, the hand held mobile computing device 110 may transmit messages to one or more of the destination devices 150 instead of, or in addition to, messages being routed by a server 145. For example, a text message to be transmitted from the hand held mobile computing device 110 may use existing mobile communications infrastructure and transmission protocols to rout such text messages directly to a destination device 150, instead of via server 145.

In this context, public networks 140 may include publicly accessible mobile telephony infrastructure as well as publicly accessible data communications infrastructure, including the internet.

The hand held mobile computing device 110 comprises at least one processor 112 and a memory 114 accessible to the processor 112 for read and write operations. The memory 114 comprises executable program code grouped into code modules that provide computing device functions. Such groups of code modules define an operating system 116 and the safety monitor application 118. Other software code modules may be stored in the memory 114 for execution, including various native device functions that can be called by the operating system 116 or safety monitor application 118. The memory 114 comprises persistent non-volatile data and program storage for implementing the operating system 116 and safety monitor application 118, but also includes volatile memory, such as random access memory (RAM).

Hand held mobile computing device 110 further comprises a display 132, which may be a display screen for a smart phone or tablet computing device display, depending on the particular embodiment of the hand held mobile computing device 110. The display 132 is driven by the processor 112 together with any additional graphics processing devices or circuitry that may be necessary or desirable for display functions.

Additionally the hand held mobile computing device 110 comprises one or more input components 134. Such input components 134 may include a transparent touch screen interface overlayed on the display 132, for example, and/or an inbuilt or electronically coupleable key pad, for example.

Hand held computing device 110 further comprises a transceiver module 136, including one or more antennae for transmitting and receiving data to and from the server 145 via the public networks 140. The processor 112 controls the transceiver module 136 to transmit and receive data according to protocols known in the art. The hand held mobile computing device 110 further comprises a location component 135, such as a global positioning system (GPS) location identification module, and one or more accelerometers 138 to detect movement of the hand held mobile computing device 110.

The system 100 is intended to be used by workers that are performing their duties alone in a potentially remote area with possible safety hazards. Provision of the safety monitoring application 118 as part of the system 100 is aimed at providing an alarm and notification system to alert one or more colleagues and/or personal contacts of the owner/user carrying the hand held mobile computing device 100, in case any events occur that are or may be potentially adverse to the safety of that person.

It should be noted that the system 100 may be used in circumstances other than just for employees of a company that may be involved in maintenance and/or inspection work. Described embodiments of the invention may also be beneficially used in a broader context by people whose safety may be of concern to others while they are involved in certain activities, including the elderly or disabled. The system 100 is therefore specifically configured to monitor for periodic feedback, such as regular movement or user input, from the user of the hand held mobile computing device 110 that would tend to indicate that no adverse event has occurred that would affect the safety or wellbeing of the user.

As described herein, the safety monitor application 118 is of a kind that may be downloaded onto hand held mobile computing device 110 from the external download server 160 and installed as one of a number of applications running on the hand held mobile computing device 110. Such a download server 160 may be commonly accessed through a link to an “App Store” for devices executing an operating system provided by Apple, Inc.™ or an “App Market” for devices running an Android™ or other operating system, for example.

Safety monitor application 118 comprises a number of software code modules that, when executed by the processor 112, cause the handheld mobile computing device 110 to perform safety monitoring functions as described herein. Such code modules include a user interface module 122, a timer module 124, a configuration module 126 and a status detection module 128. The user interface module 122 is configured to generate appropriate images displays for the safety monitor application on display 132 and to provide input options for receiving user input where appropriate. The timer module 124 is configured to execute timer functions to count down (or up) to time periods specified by default or by the user in the settings screen 600 (FIG. 6). The configuration module 126 cooperates with the user interface module 122 to allow setting of the timer parameters, contact details and other input received via the settings screen 600. Optionally, the configuration module may cause an update to be sent to the server 145 when certain new configuration settings (such as contact details for alarm message recipients) are entered into the settings screen 600 and saved onto the device memory 114. This allows the server 145 to locally store the alarm message recipient contact information (and optionally other information) and allows the alarm messages received from the computing device 110 to be shorter and therefore more reliably sent. The status detection module 128 is configured to monitor changes in apparent user status or timer status or alarm status while the safety monitor application is executing.

Referring also now to FIGS. 2 to 11, methods of providing and executing safety monitor functions of the safety monitor application 118 are described in further detail with reference to the flow charts of FIGS. 2, 3 and 4 and the example screen displays of FIGS. 5 to 9 and the example alarm messages of FIGS. 10 and 11.

FIG. 2 is a flow chart of a method 200 of providing a safety monitor application for the handheld mobile computing device 110. Method 200 begins at 210 when the safety monitor application is selected and downloaded from the download server 160 by existing application download techniques. Once the safety monitor application 118 is successfully downloaded at 210, then the safety monitor application 118 sets default configuration parameters at 220, such as default time periods, for example.

When the safety monitor application 118 is successfully downloaded onto computing device 110 or upon the safety monitor application 118 being first launched, details of the computing device 110 and any details of the user, such as name, number and email details, are provided to the server 145 in order to register the user as owner or user of the computing device 110 and the computing device 110 itself with the server 145.

At 240, the safety monitor application 118 sets a default timer mode, which, as described in further detail below, may be a motion detection mode or an interval timer mode. In some embodiments, the default timer mode may be the motion detection mode, while in other embodiments, the default timer mode may be the interval timer mode.

At 250, once the safety monitor application 118 is executing on the handheld mobile computing device 110, the user is invited and allowed to configure (by user input), alarm message contact information and timer parameters. An example configuration screen is shown in FIGS. 6A and 6B (with FIG. 6B being a vertically scrolled version of the same display as shown in FIG. 6A). The user is invited to input a mobile (cellular) telephone contact number for the handheld mobile computing device 110 and to input a user name in user identification fields 610. The user name is included in any alarm messages that are transmitted to destination devices 150 and is therefore intended to reflect the name by which the user of the computing device 110 is most commonly known.

The user may configure functions of the handheld mobile computing device 110 using the interactive display 600 of the safety monitor application 118. One configuration option may be to enable or disable the interval timer mode of the device by selection or deselection of a toggle selector 620, for example.

The user is also invited via interactive display 600 to input timer configuration parameters into motion alarm notification configuration fields 630 for configuring the motion detection alarm notifications. In this respect, the fields 630 include a first field to input a number of minutes to elapse without any motion being detected by accelerometers 138 before an alarm message is transmitted. A second field of the motion alarm notification configuration fields 630 is to specify a number of seconds that the local alarm is to run for. For example, if the time interval entered in the first field of fields 630 were twenty minutes and the timer timeout were ten seconds (in the second field), then if there were no motion detected for twenty minutes, an alarm would sound for ten seconds, locally emitted from the computing device 110.

The user may also configure first and second interval timer alarm notification configuration fields 640, inputting a number of minutes that the interval timer is to run for in a first field and a number of seconds in the second field that the alarm is to sound for once the interval expires. If the user does not provide input in fields 630 or 640 or sets them to improper or impractical values, those fields are populated with default configuration parameters by the parameter configuration module 126.

Additionally, the user may be allowed to configure whether a messaging alarm is transmitted using a messaging alarm configuration tool 650 that includes an enabling toggle selector 655 and an input field to input a contact mobile (cellular) telephone number to be the recipient of the messaging notification if an alarm condition occurs. Similarly, the user may configure an email alarm configuration tool 660 by selection of a selectable toggle selector 665 and inputting an email address into a recipient field. The messaging and email alarm configuration tools 650 and 660 may each allow one, two, three (or possibly more) recipients to be contacted in the event of an alarm condition occurring.

Referring again to FIG. 2, after the user has configured the settings of the safety monitor application 118 at 250, the safety monitor application may allow the user to change timer mode at 255, for example, by selecting a “toggle mode” selectable option 860 (FIG. 8). If the selectable option 860 is selected, then at 260, the safety monitor application 118 changes the timer mode to another timer mode. While only two timer modes are described herein and depicted in the drawings, embodiments may include a third or fourth timer mode, for example, and changing of the timer mode 260 may toggle through all available timer modes. Depending on the timer mode that is selected, then either method 300 or 400 (as described in further detail below) is performed at 260.

After 255 or 260, the status detection module 128 monitors for a change in status of the user's interaction with the safety monitor application 118 at 265. This change in status may be triggered by user input or may be determined based on an alarm condition or by a change in timer mode, for example. The status change monitoring at 265 is also performed continually by the status detection module 128, during the performance of methods 300 and 400. If a status change is detected at 265, then the status detection module 128 of the safety monitor application 118 transmits a status update message to the server 145, which logs the status update in relation to data records pertaining to the registered user and computing device 110 at 270.

Referring also now to FIG. 3, the method 300 of executing a safety monitor application in a motion detection mode is described in further detail. Method 300 begins at step 305 when the “no motion” or motion detection mode is selected following step 260. In the motion detection mode, the safety monitor application 118 is idle until at 310 the timer start button 730 (FIG. 7) is selected in order to start the timer. Once the timer start button 730 is selected, then at 312, the timer module 124 checks whether recipient contact details have been stored in the device memory 114. If no such details are stored or they do not seem to be valid (according to basic format checks), then an error message is displayed at 314 and the timer is not started. If seemingly valid contact details are stored in memory 114, then at 315, the timer module 124 of the safety monitor application 118 checks whether the interval and time out periods have been populated into configuration fields 630 and, if not, then at 320, the default monitor period is set and stored. If interval and time out periods have been stored, the timer 124 begins a timer function at 325 to count down the specified or default motion detection interval.

If at any time while the timer is running, movement above a threshold amount (that is pre-configured within the software code of safety monitor application 118 when it is downloaded onto computing device 110) is detected according to signals received from the accelerometer 138 at 330 then the timer is reset to begin again at 325. The threshold amount of movement to be detected before determining that there is device movement is configured to avoid resetting the timer because of small vibrations picked up by the accelerometers 138.

If the monitor period expires at 335 without movement being detected at 330, then a local alarm signal is emitted at 340 and then at 345 the safety monitor application 118 generates and transmits an alarm message to the server 145 using the transceiver module 136. At 350, the server 145 logs the generation of the alarm message and generates and sends alarm messages to the contacts specified in the alarm message received from the computing device 110 or previously received from the computing device 110.

The local alarm signal emitted at 340 and at other alarm conditions (e.g. at 445 or when the panic alarm button is held down) is configured to be a piercing high-pitched human-audible sound that over-rides any physical or software muting or volume control of the device sound and is emitted at maximum device volume. The emitting of a high-pitched sound at full volume more reliably pierces background noise in order to reliably notify the user (and possibly others who might hear it from nearby) that the alarm condition has been triggered (i.e. by timer expiry).

The alarm message preferably includes information to identify the nature of the alarm, the computing device 110 that the alarm is being transmitted from and the user concerned and optionally also the time interval (in minutes) that expired to trigger the alarm event. Example alarm messages are shown and described in relation to FIGS. 10 and 11 below. Additionally, the safety monitor application 118 transmits with the alarm message location identification information, such as the GPS position determined by the location component 135, for example. This location identification information may include an exact GPS location or may include an estimated location.

In response to receiving the alarm message from the computing device 110, the server 145 generates and sends alarm messages to the configured contacts. Such messages are routed by conventional means to one or more destination devices 150. Such destination devices 150 need not be a physical device associated with the contact, for example, where the contact information given is an email address that is not routed directly to a physical device.

The safety monitor application 118 emits the local alarm signal at 340 until at 355 user input is received to cancel the local alarm at 360. The local alarm may automatically cancel after expiry of the timer timeout period configured in alarm configuration fields 630 and 640.

Referring also now to FIG. 4, a method 400 is described for executing the safety monitor application in an interval timer mode. Method 400 begins at 405, following selection of the interval timer mode at 260. Until the timer start button 730 is selected at 410, the timer awaits user input. Once input is received at 410 to start the timer, then at 412, the timer module 124 checks whether recipient contact details have been stored in the device memory 114. If no such details are stored or they do not seem to be valid (according to basic format checks), then an error message is displayed at 414 and the timer is not started. If seemingly valid contact details are stored in memory 114, then at 415, the timer module 124 checks whether suitable timer periods have been configured for the interval time mode. If no timer period (or no suitable timer period) is determined to be configured at 415, then timer module 124 sets a default timer period at 420 and then begins the timer at 425.

In the interval timer mode, if user input is received to stop the timer at 430, then the timer is stopped at 435. Otherwise, the timer module 124 waits for the timer period to expire at 440. Once the timer period expires at 440, the local alarm signal is emitted at 445 and then at 450, the safety monitor application 118 generates and transmits an alarm message to the server 145 similar to the alarm message transmitted at 345 but indicating that the timer was in the interval timer mode, rather than the motion detection mode. At 455, the server 145 sends alarm messages to stored contacts in a similar manner to step 350 described above. In some embodiments, the handheld mobile computing device 110 may be configured to transmit text messages, such as SMS (short messaging service) directly to a destination device 150 via public mobile telephony network infrastructure. This may be done instead of or in addition to transmission of such text messages via server 145.

If at step 460, user input is received to cancel the local alarm, then the local alarm is cancelled at 465 and the timer is reset at 425 to begin again.

In either the motion detection mode or the interval timer mode, a panic alarm button may be provided which allows the user of the computing device 110 to cause a panic alarm message to be transmitted to the contacts via server 145 (whether or not the timer is running in either mode). This panic alarm button may be in the form of a start button 730 or a stop button 830 (FIG. 8) and may be activated by holding that button for a pre-configured activation period. Alternatively, the panic alarm button may be a separate button to the start and stop buttons 730, 830. The panic alarm may optionally be activated only during the execution of the timing function following steps 325 or 425 or alternatively may be activatable at any time, even if a timer is not running. Once the panic alarm button is pressed at 365 or 470 and held for the activation period at 370 or 475, then a local alarm signal is emitted at 340 or 445 and the safety monitor application 118 generates and transmits an alarm message to the server at 350 or 455, as described previously.

In order to be able to provide the location identification information as part of an alarm message, the location component 135 regularly and periodically determines the geographic location of the computing device 110 and provides this to the processor 112, which stores it in memory 114 for use in case an alarm message is to be transmitted.

The location component 135 may be configured to determine the geographic location of the computing device to within a calculated accuracy. This calculated location accuracy may be transmitted along with the determined or estimated geographic location of the computing device 110 when an alarm message is transmitted to the server 145. The relative location accuracy may be indicated on a display generated by the user interface 122, examples of which are shown in FIG. 7 as 720 and in FIG. 8 as 820. The location accuracy may be displayed as a number and/or qualitative indication such as “good”, “poor” or “unknown”. The location accuracy information may be useful information for the user to know, for example where the user is in a low-reception area and the user is about to begin work and intends to rely on the safety monitor application 118.

FIGS. 5A, SB and SC illustrate example displays of introduction pages 510, 520 and 530 displayed to a user viewing the safety monitor application 118 (as generated by the user interface 122) for the first time or in response to selection of a “help” or “information” option displayed on one of the other screens. A first introduction page 510 may explain that the safety monitor application 118 acts as an emergency beacon in the pocket of the user, so that in an emergency, the safety monitor application informs, for example, three colleagues via SMS and email that the user is not responding and gives the colleagues the user's last location. Introduction page 520 may explain that in one timer mode, which may be referred to as a health detection mode, the user may configure a time period by which the user would intend to routinely provide user input to the device 110 and that the safety monitor application 118 will alarm locally upon expiry of that time period without receiving user input. If the safety monitor application 118 generates an alarm and no further input is received, then the safety monitor application 118 will generate and send alarm messages to one or more contacts including the last determined geographic location of the computing device 110. In introduction screen 530, the motion detection mode may be explained in a similar manner to the health detection mode in screen 520.

FIG. 7 is an example display of a home screen 700 for an interval timer mode. The home screen 700 may display a configuration option 705 to allow the user to reconfigure the alarm and notification settings as described above in relation to FIGS. 6A and 6B. Home screen 700 may further comprise a banner area 710 that identifies a name and contact address or phone number of the user of the handheld mobile computing device 110. In a main portion of the home screen 700, the start button 730 is provided to enable the user to start the interval timer. This toggles to a “stop” button (as shown in FIG. 8) once it is pressed. A count down timer display may be included in a portion 720 of the home screen 700, to indicate the time remaining until the end of the timer period, optionally together with an indication of the GPS location accuracy determined by the location component 135 in combination with the processor 112.

Home screen 700 may also comprise a mode identification banner 740, together with an indication of the full interval period configured for that mode. Home screen 700 may also comprise a status banner 750 to indicate the current status (ie active, inactive or alarm generated, for example), together with the time at which the status was most recently changed.

FIG. 8 shows an example home screen 800 for a motion detection mode of the safety monitor application 118. The motion detection mode is displayed in a banner 840. The stop button 830 is in a central portion of the home screen 800 and is indicated to function as a panic alarm button at 835 if held down. A banner 845 may also indicate the timer period after which an alarm will be generated if no motion is detected. An alarm notification period 820 may indicate the remaining time until alarm as long as no motion is detected.

FIG. 9 is an example display 900 of a message 910 that appears (as generated by user interface 122) when an alarm condition occurs and step 350 or 455 has been performed. The display 910 indicates that the alarm has been sent on behalf of a named user at 915 and indicates a destination mobile phone or cell phone number to receive an SMS message at 920, plus an email address shown at 925 to which an email alarm message will be sent. The user may tap the display 910 to dismiss it, as indicated at 930.

FIG. 10 shows an example email message display 1000 received at a destination device 150. The display 1000 may include a banner 1010 and alarm description 1020 to indicate the date and time of the alarm. Additionally, a title of the alarm condition may be indicated in a portion 1030 of the message. The reason for the occurrence of the alarm condition may also be provided in a portion 1040. The user of the handheld mobile computing device 110 may be indicated in a portion 1050 of the message.

Finally, the last recorded location of the handheld mobile computing device 110 may be indicated by GPS coordinates or as a selectable link 1060 to view the location on a map application installed the destination device 150.

FIG. 11 shows an example text message display 1100 of an alarm message received by SMS. The alarm message 1110 indicates a reason 1140 for the generation of the alarm, indicates the name of the user 1150 of the handheld computing device 110 that generated the alarm and indicates a selectable link 1160 to display the last recorded location of the computing device 110 on a map. The link 1160 may be embedded in the text message in such a way as to include a human readable GPS location 1165, for example in the form of GPS coordinates.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. In a handheld mobile computing device comprising a movement detecting component and a wireless communication subsystem, a method of providing a safety monitor application, the method comprising:
within the safety monitor application, allowing user configuration of a monitor time period;
executing a timer function to run a timer from a beginning of the monitor time period;
in response to a signal from the movement detection component indicative of movement of the mobile computing device by more than a threshold movement amount, resetting the timer to run from the beginning of the monitor period;
in response to the timer reaching an end of the monitor time period, generating and transmitting an alarm message to at least one remote destination using the wireless communication subsystem of the handheld mobile computing device.

2. The method of claim 1, further comprising, in response to a user input to the mobile computing device, resetting the timer to run from the beginning of the monitor period.

3. The method of claim 1, wherein the alarm message is transmitted to at least two pre-configured contacts.

4. The method of claim 1, wherein the mobile computing device has a geographic location identification function and the method further comprises determining a geographic location of the mobile computing device, wherein the alarm message includes at least one of a geographic location and a selectable link to display the geographic location.

5. The method of claim 1, wherein the alarm message comprises an indication of the monitor time period.

6. The method of claim 1, wherein the generating and transmitting is performed after a pre-configured delay period after the end of the monitor period.

7. The method of claim 4, further comprising determining a location accuracy of the determined geographic location, wherein the alarm message includes the location accuracy.

8. The method of claim 4, wherein determining the geographic location is performed repeatedly during the monitor time period.

9. The method of claim 7, further comprising displaying on a display of the mobile computing device an indication of the location accuracy.

10. The method of claim 1, further comprising displaying on a display of the mobile computing device an indication of a remaining time until the end of the monitor period.

11. The method of claim 1, further comprising displaying on a display of the mobile computing device a panic alarm option, wherein the method further comprises, in response to selection of the panic alarm option, generating and transmitting a panic alarm message to the at least one remote destination.

12. The method of claim 1, further comprising displaying on a display of the mobile computing device a selectable timer initiation option, wherein in response to selection of the timer initiation option, the timer function causes the timer to run from the beginning of the monitor time period.

13. The method of claim 1, wherein the at least one remote destination is a server paired with the safety monitor application, wherein the server is configured to generate and transmit one or more alarm messages to one or more destination devices.

14. A safety monitor system for implementation in a handheld mobile computing device comprising a movement detecting component and a wireless communication subsystem, the system comprising:
at least one processor;
memory accessible to the at least one processor and storing program code executable by the at least one processor to cause the at least one processor to:
allow user configuration of a monitor time period;
execute a timer function to run a timer from a beginning of the monitor time period;
in response to a signal from the movement detection component indicative of movement of the handheld mobile computing device by more than a threshold movement amount, resetting the timer to run from the beginning of the monitor period;
in response to the timer reaching an end of the monitor time period, generating and transmitting an alarm message to at least one remote destination using the wireless communication subsystem of the handheld mobile computing device.

15. A method of providing a safety monitor application, comprising:
downloading the safety monitor application onto a handheld mobile computing device comprising a movement detecting component and a wireless communication subsystem;
wherein the handheld computing device further comprises at least one processor and memory accessible to the at least one processor and storing program code executable by the at least one processor;
wherein in response to the downloading, the program code stored in the memory includes the safety monitor application;
wherein execution of the safety monitor application by the at least one processor causes the at least one processor to:
allow user configuration of a monitor time period;
execute a timer function to run a timer from a beginning of the monitor time period;
in response to a signal from the movement detection component indicative of movement of the handheld mobile computing device by more than a threshold movement amount, resetting the timer to run from the beginning of the monitor period;
in response to the timer reaching an end of the monitor time period, generating and transmitting an alarm message to at least one remote destination using the wireless communication subsystem of the handheld mobile computing device.

16. In a handheld mobile computing device comprising a location detecting component and a wireless communication subsystem, a method of providing a safety monitor application, the method comprising:
within the safety monitor application, allowing user configuration of an interval time period;
executing a timer function to run a timer from a beginning of the interval time period;
in response to user input to reset the timer, resetting the timer to run from the beginning of the interval period;
determining a geographic location of the handheld mobile computing device;
in response to the timer reaching an end of the interval time period, generating and transmitting an alarm message to at least one remote destination using the wireless communication subsystem of the handheld mobile computing device, the alarm message including the determined geographic location.
